(19) United States
(12) Patent Application Publication
(10) Pub. No.: US 2011/0017339 A1
(43) Pub. Date: Jan. 27, 2011

(54) METHOD FOR ROLLED SEAMLESS CLAD PIPES

(75) Inventor: Bhaven Chakravarti, Bellaire, TX (US)

Correspondence Address: Levenfeld Pearlstein, LLC;Intellectual Property Department, 2 North LaSalle, Suite 1300, Chicago, IL, 60602, US

(73) Assignee: CHAKRAVARTI MANAGEMENT, LLC, Bellaire, TX (US)

(21) Appl. No.: 12/537,986

(22) Filed: Aug. 7, 2009

Related U.S. Application Data
(63) Continuation-in-part of application No. 12/508,291, filed on Jul. 23, 2009.

(51) Int. Cl. F16L 9/14; B21D 39/04

(52) U.S. Cl. 138/143; 228/127

(57) ABSTRACT

A method of forming clad piping or tubing includes the steps of forming an assembly of a support billet having a cladding surface and a cladding material billet, sized to cooperate with the cladding surface of the support billet, with an interface gap defined between the cladding material billet and the cladding surface of the support billet, sealing the interface gap, evacuating the interface gap and metallurgically bonding the cladding material billet to the support billet by a Hot Iso-static Pressing or weld overlay process to form a composite billet, and hot-rolling through a rotary mill the composite billet to form the clad piping or tubing.

### CROSS-REFERENCE TO RELATED APPLICATION DATA

This application is a continuation-in-part of U.S. patent application Ser. No. 12/508,291, filed Jul. 23, 2009.

### BACKGROUND OF THE INVENTION

The present invention relates to clad piping and tubing, and more particularly to a method of manufacturing seamless clad piping and tubing from a composite billet.

One method of manufacturing seamless clad piping and tubing is to hot co-extrude a composite billet at high temperature in an extrusion press, a common technique for the manufacture of other seamless pipes and tubes. The cylindrical extrusion billet is a composite of carbon or low alloy material on the outside and a corrosion resistant alloy (“CRA”) on the inside or vice versa. The range of sizes, wall thicknesses, and alloy combinations available in the final product is restricted by the nature and production techniques of the composite billet that is used.

In one exemplary process for billet production, as described in Osborn, U.S. Pat. No. 5,988,484, the disclosure of which is incorporated herein by reference, the starting CRA and carbon steel (“CS”) cylinders are machined to pre-calculated dimensions that allow for an accurate interference fit. When the CS outer cylinder is heated, it expands at the interface position creating a gap between the CRA and CS cylinders, causing the CS cylinder to slip over the CRA inner cylinder. As the assembly cools to room temperature the carbon steel contracts creating an interference fit with the CRA inner cylinder.

Another cladding process describing an outside diameter or OD clad pipe product is disclosed in Sponseller, U.S. Pat. No. 5,558,150, the description of which is incorporated herein by reference. The process is based on centrifugal casting of both the clad material and support material, in sequence, to form a composite billet, with the support material mechanically lining the CRA material, and without creating a bond between the two materials. As described more fully in Sponseller, the method seeks to inhibit metallurgical bonding and interdiffusion between the support and clad layers by strictly controlling the temperature and time interval between which the layers are consecutively poured.

Both of the above methods describe a composite billet that does not have any metallurgical bond between the outer carbon steel billet and the inner CRA cylinder. They are solely mechanically fitted together by interference fit which creates several drawbacks in extrusion as described below.

For example, during heating of the composite billet in preparation for hot extrusion, the support carbon steel billet material and the CRA cladding material grow or expand differently (i.e., at different rates), with the interface between them opening up, as they are only mechanically lined or interference fit rather than metallurgically bonded to each other. This can cause the subsequent extrusion to fail as the CS and CRA materials tend to extrude independently of each other. As the high temperature thermal expansion, physical and mechanical properties of the two materials that form the composite billets differ by larger and larger amounts, the difficulty in extrusion of these billets rises exponentially.

Chakravarti, U.S. Pat. No. 6,691,397 discloses one method developed to avoid these drawbacks, in which the composite clad billet of support carbon steel billet material and the CRA cladding material is metallurgically bonded prior to extrusion at high temperature to assure that both materials are extruded together to form a clad pipe or tube.

While metallurgically bonding the composite clad billet improved extrusion results, it did not provide a solution for all combinations of pipe sizes, wall thicknesses and material combinations required. During coextrusion of the metallurgically bonded composite billet it was observed that as the percentage of the cladding thickness gets smaller in comparison to the total wall thickness of the pipe, coextrusion becomes more difficult, and becomes considerably more severe for cases in which the physical and mechanical property differences between the support and clad materials are large at extrusion temperatures.

As the extrusion process starts, the composite billet positioned in the extrusion can with the mandrel going through the central bore is pressed to the chamber wall and forced to extrude through the annular opening between the die and the mandrel. This initial upsetting that directs the flow of metal to the annulus created between the die opening and the mandrel results in a non equilibrium flow, which is observed as the majority of the pipe wall extruding out is that of CRA. As the extrusion process proceeds and reaches a steady state flow, the proper proportion of the CRA and CS are seen in the extruded pipe. For most cases of composite billets this process works well, however, as the CRA thickness gets smaller and smaller in comparison to the total wall thickness of the pipe, and with certain combinations of material, the equilibrium flow is never achieved for the full length of the pipe. The CRA cladding that exits the die has variable thickness longitudinally and circumferentially through the entire extruded length of the pipe. This variation of cladding thickness has been found to be difficult to control in the extrusion process.

Accordingly, there is a need for a method for manufacturing seamless clad pipe from a metallurgically bonded composite billet for materials that have greater thermal expansion, physical and mechanical property differences. Desirably, such a method produces a clad pipe with consistent wall thickness of base material and clad alloy without adversely affecting the properties and characteristics of either.

### BRIEF SUMMARY OF THE INVENTION

A method for producing a clad pipe or tube from a composite billet that is assembled from a corrosion resistant alloy (“CRA”) cylinder and a carbon steel (“CS”) cylinder, ends closed, evacuated and then subjected to a Hot Iso-static Pressing (HIP) process to create a High Temperature Metallurgical Bond (HTMB) between the billet interfaces. The CRA material may also be applied to the inside of the CS billet by, for example, a weld overlay process. The composite billet is then advanced through a high reduction rotary rolling mill preferably having three (3) rollers offset at 120° together with a mandrel rod to control the ID dimension by which the billet is compressed and reduced in diameter uniformly into its final shape, such as a pipe or tube.

The composite billet is hot rolled on an outside surface of the composite billet while the mandrel is positioned on the inside of the composite billet to maintain an inner diameter of the finished clad pipe or tube. While each conical roller rotates along its own axis, all three rollers also rotate around the billet material in a planetary motion, producing a conical reducing zone. This form of hot rolling provides a simple, more controlled reduction of the wall of the composite billet from all sides, stretching and elongating the composite billet into a clad pipe or tube.

The outside support billet can be formed by any technique that can produce a hollow, preferably cylindrical, section. It can be formed from a hollowed or trepanned ingot, a forged, upset, extruded or ring rolled section from such ingot or from a centrifugal casting. Generally, the most cost-effective method of producing the required wall thickness and length of such a cylindrical section will be selected for use. It is not important that the section be forged, as HIPing and hot rolling during clad piping manufacture will further consolidate the cast microstructure. This support section is finished, such as by machining, to the proper dimensions of the required support material for the assembly of the composite billet.

Similarly, the CRA cylinder that is fitted on to the inner surface of the support cylinder to produce the composite billet, can also be formed by a number of techniques. It can be formed from a hollowed or trepanned ingot or bar, an extruded section or from a centrifugal casting. Again, the most cost-effective method of producing the required wall thickness and length of this CRA cylindrical section will be utilized. Since this section is also further consolidated by HIPing and hot rolling, it is not important that the section be of wrought microstructure. This CRA section is finished, such as by machining, to fit with slight clearance inside the support carbon or low alloy cylinder.

A method of controlling the dimensions of clad piping or tubing includes the steps of providing a support billet and a CRA billet of accurate dimensions, to provide a predetermined amount of base and clad material in forming a composite billet, with the clad material metallurgically bonded to the support billet. The amount of clad material is predetermined based upon the desired inside or outside diameter of the piping or tubing. The composite billet is finished, such as by machining, to precise, predetermined inside and outside dimensions, and the HIP'd composite billet is hot rolled into the desired finished dimensions.

It is believed that the metallurgical bond between the support billet and the CRA inhibits separation of the support billet and cladding material during subsequent hot rolling of the billet into the clad tubing or piping product.

By metallurgically bonding the clad material to the support material in forming the composite billet, and subsequently hot rolling the composite billet, the present process overcomes many of the difficulties of known composite billet extrusion processes, which occur due to the upsetting and complex material flow required, for the subsequent transformation into the final pipe or tube. By having a solid state metallurgical bond this invention also avoids mixing and pickup of alloying elements into the support material from the clad and vice versa and further avoids precipitation of second phases and defects at the interface of the support and clad materials. The invention also allows for a wide range of clad and support materials to be used and results in an economical method of forming clad piping and tubing.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 shows a partial cross sectional view of the support billet prior to assembling into a composite billet;

FIG. 2 shows a partial cross sectional view of the CRA billet prior to assembling into a composite billet;

FIG. 3 shows a composite billet with the interface sealed with end caps to exclude air;

FIG. 4 illustrates an alternate method for producing a composite billet that employs a third cylinder internal to the CRA cladding material for ease of fabrication;

FIG. 5 shows a side view of the hot rolling system on a composite billet;

FIG. 6 shows a cross-sectional view of the hot rolling system of FIG. 5 at A-A on a composite billet; and

FIG. 7 shows a final clad pipe product.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated. It should be further understood that the title of this section of this specification, namely, “Detailed Description Of The Invention”, relates to a requirement of the United States Patent Office, and does not imply, nor should be inferred to limit the subject matter disclosed herein.

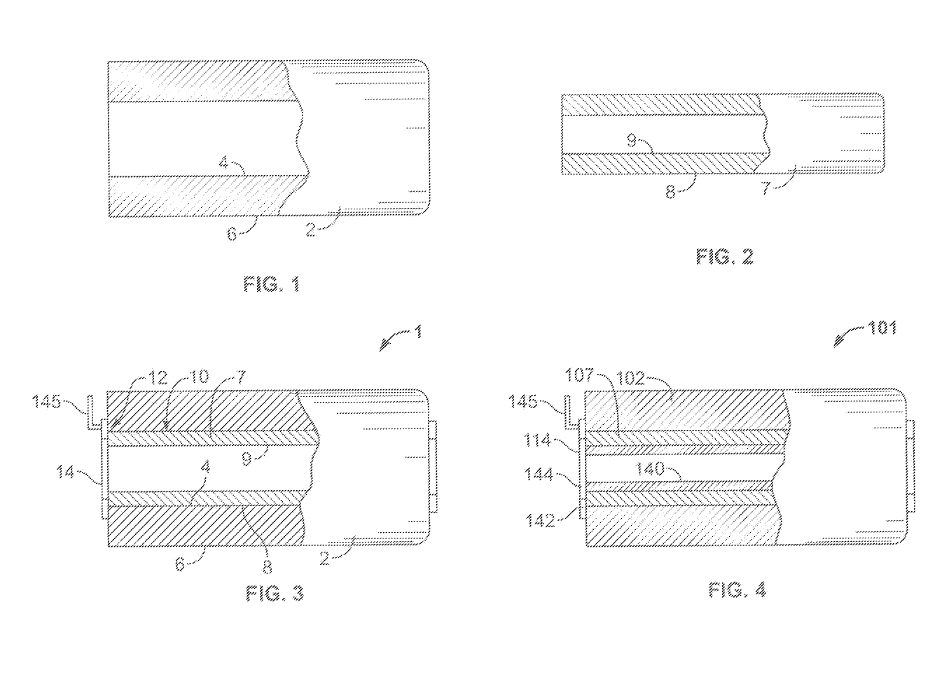

Referring to the figures and more specifically to FIGS. 1 and 2, there is shown a billet 1 formed from a cylindrical support billet 2 and a CRA billet 7. The support billet 2 is formed, for example, from a metal ingot, forging, extrusion or centrifugal casting and is finished, such as by machining, to an exact dimension. The support billet 2, which has an inner surface 4 and an outer surface 6, is formed by removing the center section of the metal ingot or bingot by, for example, heating the ingot or bingot and punching out or trepanning a cylindrical shaped center portion. The inner and outer surfaces 4, 6, respectively, of the cylindrical support billet 2 can then be machined to assure concentricity and dimensions of the finished support billet. The support billet 2 can be formed from any of a variety of materials including carbon steels, carbon manganese steels, low alloy steels, chrome-moly steels, high yield grades, high strength low alloy steels and the like. The dimensions of the billet are as required by the final composite billet dimensions for hot extrusion.

The cylindrical CRA billet 7 is formed from, for example, a metal ingot, forging, extrusion or centrifugal casting and is finished, such as by machining, to an exact dimension. The CRA billet 7, which has an outer surface 8 and an inner surface 9, can be formed by removing the center section of the metal ingot or bar, for example, by heating the ingot, punching and extruding or trepanning a cylindrical shaped center portion from the bar. The outer and inner surfaces 8, 9, respectively, of the cylindrical CRA billet 7 can then be finished, such as by machining, to assure concentricity and dimensions as required by the final composite billet dimensions for assembly.

The CRA billet 7 can be formed from a variety of corrosion resistant alloys such as, for example, stainless steels, such as austenitic stainless steels, super austenitic stainless steels, duplex stainless steels, ferritic and martensitic stainless steel, chromium containing iron-nickel base alloys such as UNS 08825, chromium containing nickel base alloys, cobalt base alloys, nickel-cobalt base alloys, heat and corrosion resistant chromium containing nickel base, iron/nickel base alloys and the like, Incoloy 825, various nickel based alloys such as Nickel 200, Monel 400, Inconel 625 and Hastelloy C276, which alloys are commercially available from Special Metals Inc. (Huntington, W. Va.) and Haynes International, Inc. (Kokomo, Ind.), and their equivalent generic alloys among others and other intermediate and refractory metal (Ti, Zr, etc) based alloys. Those skilled in the art will recognize the wide variety of other cladding materials, including erosion resistant alloys that can also be used.

In carrying out the present method, the CRA billet 7 is slipped inside the support billet 2, to form billet 1, and the interface between the two cylinders, indicated generally at 10, is protected from oxidizing (e.g., forming a scale and creating a barrier to bonding) by sealing the two open interface ends 12 by welding end covers 14. The interface 10 gap volume is evacuated to remove any oxygen and billet 1 is heated for Hot Iso-Static Pressing (HIP).

During the HIP operation, the entire assembly (i.e., billet 1) is exposed to a predetermined temperature, for a predetermined amount of time with the concurrent application of high pressure in an autoclave HIP vessel. This uniform (isostatic) application of high pressure at high temperature causes the inside surface 4 of the support billet 2 to bond together with the outer surface 8 of the CRA cylinder 7 by high temperature diffusion bonding. The as-assembled composite billet 70 interfaces and forms a metallurgical bond by the Hot Iso-statically Pressing of the CRA cladding alloy billet 7 to the support carbon steel billet inner surface 4. The predetermined temperature and time are based on the properties of the clad material and base material selected. In a current application, in which an API 5L, Grade X65 and higher grades of base material having various wall thickness are bonded with Alloy 825 cladding, the HIP cycle would be at a pressure over about 15,000 psi and at a temperature over about 2000 degree F. for about at least 2 hours to about 24 hours.

After HIP processing, the now composite billet 70 is cooled, the end caps 14 are cut, and the composite billet 70 is finished, such as by machining, on the outside surface 6 of the support billet 2 material surfaces. The inside cladding material surface 9 is also finished, such as by machining, to the desired dimensions for hot rolling through a high reduction rotary mill.

In an alternate method for producing a composite billet 101, a third, thin walled carbon steel cylinder 140 is inserted into the inside of the CRA cylinder. As seen in FIG. 4, this allows the ends caps 114 to be welded between the outside carbon steel support cylinder 102 and the third, inside carbon steel cylinder 140, as indicated generally at 42 and 44, respectively. This reduces the possibility for adverse welding issues vis-à-vis the carbon steel support cylinder 102 and the inner CRA cylinder 107, thus increasing or enhancing the seal welds 42, 44 for oxygen evacuation. This is particularly useful when CRA cylinders 107 of difficult to weld materials are utilized in the manufacture of the composite billet 101.

When such a third CS cylinder 140 is utilized in creating the composite billet 101, the inside CS cylinder 140 is finished, such as by machining, to the required CRA 107 inside diameter surface to prepare the billet 101 for HIP processing. After HIP processing, the inside CS cylinder 140 is removed for hot rolling of the composite billet.

It will be appreciated by those skilled in the art that although the above billet 7 is discussed as formed by a HIPing process, other processes may be used to produce such a billet. For example, a billet may be produced by a weld overlay process that will be recognized by those skilled in the art, such as that disclosed in Neill, U.S. Pat. No. 6,350,327, which billet is then further fabricated, as by hot rolling, to form the present clad pipe.

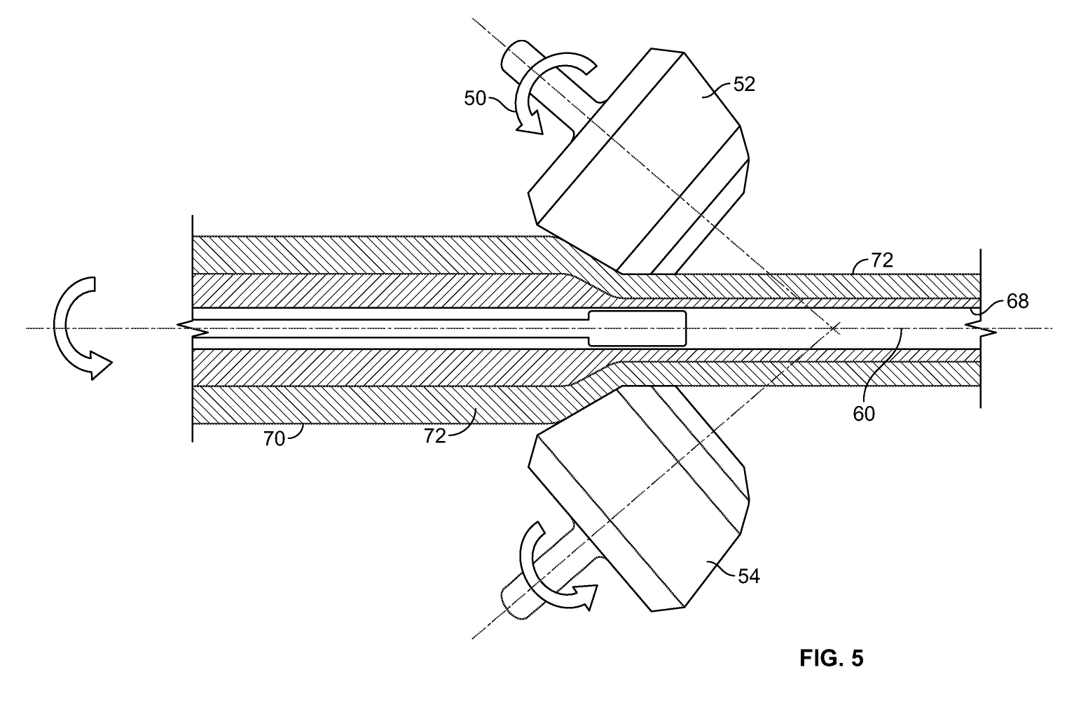

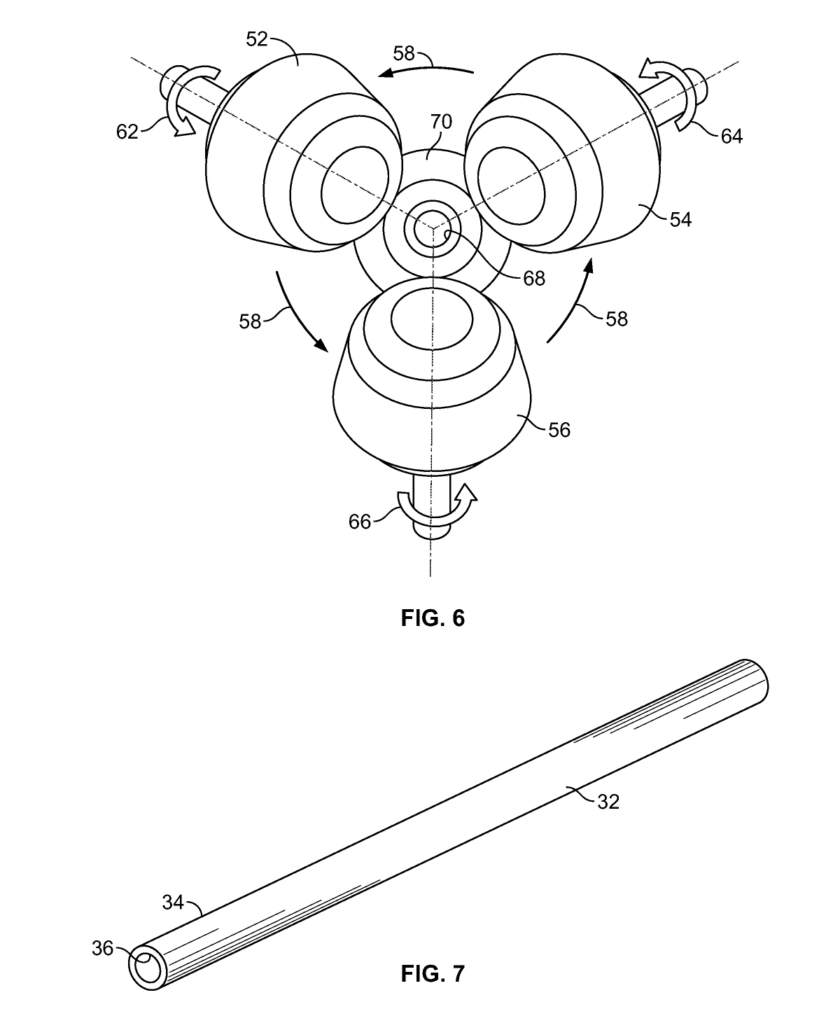

Turning now to FIGS. 5 and 6, a present method of producing clad pipe or tube is shown. A rolling mill 50 utilizes three (3) hot rollers 52, 54, and 56. Each of the hot rollers 52, 54, 56 are positioned 120 degrees apart from one another along a circumference of a mandrel rod 68 and each rotate around separate axes, as indicated generally at 62, 64, and 66 respectively. These axes are positioned at angles to a central axis passing longitudinally through the center of the mandrel 68, which is determined by the exact shape of the rollers and the desired reduction required. The mandrel 68, properly sized to produce the desired inside diameter of the clad pipe section, is placed in the bore of the heated composite billet 70. The hot rollers 52, 54, 56 are configured to rotate in a planetary motion around the mandrel, as indicated generally at 58.

The present method produces a conical reduction zone, shown in general at 72, producing a reduction in the cross-section of the composite billet 70 while controlling the wall thickness of the clad pipe along an entire length of the clad pipe (shown in FIG. 7). Each of the hot rollers 52, 54, and 56 operate in concert to simultaneously compress, reduce, and smooth the composite billet into a final clad pipe. As will be appreciated by those skilled in the art, it may be necessary for the rolled clad pipe to pass through other continuous sizing and finishing rolling sections (not shown) to produce the finished product.

During hot rolling of the heated composite billet 70, both the support and cladding material, which are metallurgically bonded, are compressed and reduced as it passes through the conical reduction zone 72. The metallurgical bond formed during the Hot Iso-static Pressing process is further enhanced during the hot rolling process of producing the clad piping such that localized areas between the clad material and the support billet that may not have bonded during the HIP process are healed and the interface bonding of the support material and the cladding material is enhanced.

This process permits control of the interface dimension and the specific wall thickness required for base material and cladding. This is especially significant if the final pipe produced must meet minimum wall thicknesses for both the support material and the cladding material to be an acceptable product. Having the proper thickness of the two components in the composite billet 70 assures proper wall thickness of the support and clad material in the final product.

A finished clad pipe section 74 formed from a composite billet 70 manufactured in accordance with the principles of the present invention is shown in FIG. 7. The clad piping section includes an outer support surface 34 and an inner clad surface 36. In this embodiment, the outer support surface 34 provides support (i.e., stress and pressure boundary), whereas the inner tube 36 provides a corrosion or erosion resistant fluid interface barrier or boundary to the transported fluid.

The hot rolled clad pipe section can then be further heat treated, blast cleaned on the outside and inside surfaces and tested ultrasonically for quality of bonding created and to identify any defects that may have occurred during rolling. Standard ultrasonic testing techniques can be used to check bond quality and to identify any potential defects in the clad pipe section. Typically, samples of the material are taken for testing of mechanical and chemical properties.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A method of forming clad piping or tubing comprising the steps of:
forming an assembly comprising a support billet having a cladding surface and a cladding material billet, sized to cooperate with the cladding surface of the support billet, with an interface gap defined between the cladding material billet and the cladding surface of the support billet;
sealing the interface gap;
evacuating the interface gap;
metallurgically bonding the cladding material billet to the support billet by a Hot Iso-static Pressing process to form a composite billet; and
hot-rolling through a rotary mill the composite billet to form the clad piping or tubing.

2. The method in accordance with claim 1 wherein the support billet is formed by centrifugal casting.

3. The method in accordance with claim 1 wherein the support billet is formed by weld overlay.

4. The method in accordance with claim 1 wherein the support billet is cylindrical.

5. The method in accordance with claim 1 wherein the cladding material is a corrosion resistant alloy and the support material is a carbon or low alloy steel material.

6. The method in accordance with claim 1 wherein the cladding material is an erosion resistant alloy and the support material is a carbon or low alloy steel material.

7. The method in accordance with claim 1 wherein the cladding material billet is cylindrical.

8. The method in accordance with claim 1 wherein the cladding surface is an outer surface of the support billet.

9. The method in accordance with claim 1 wherein the cladding surface is an inner surface of the support billet.

10. The method in accordance with claim 1 wherein the support billet has two cladding surfaces, an inner surface and an outer surface.

11. A product formed by the method of claim 1.

12. The method in accordance with claim 1 including the step of a positioning a sealing billet on a aide of the cladding material billet opposite of the support billet such that the cladding material billet is disposed between the sealing billet and the support billet prior to evacuating the interface gap.

13. A method of controlling the dimensions of hot rolled clad piping or tubing comprising the steps of:
providing a support billet finished to a desired dimension and having an inner surface;
providing a machined cladding material billet, finished to a desired dimension;
concentrically positioning the cladding material billet and the support billet, with an interface gap defined between the cladding material billet and the support billet;
sealing the interface gap;
metallurgically bonding the cladding material billet to the support billet by a Hot Iso-static Pressing process to form a composite billet;
finishing the composite billet to a predetermined inside dimension and a predetermined outside dimension; and
advancing the composite billet through a hot rolling rotary mill having a mandrel rod to form a dimension controlled clad pipe or tube.

14. The method in accordance with claim 13 wherein the support billet is formed by centrifugal casting.

15. The method in accordance with claim 13 wherein the support billet is formed by weld overlay.

16. The method in accordance with claim 13 wherein the support billet is cylindrical.

17. The method in accordance with claim 13 wherein the cladding material billet is formed from a material that is a corrosion resistant alloy and the support billet is formed from a material that is a carbon or low alloy steel material.

18. The method in accordance with claim 13 including the step of evacuating the interface gap.

19. The method in accordance with claim 18 including the step of positioning a sealing billet on a side of the cladding material billet opposite of the support billet such that the cladding material billet is disposed between the sealing billet and the support billet prior to evacuating the interface gap.

20. A product formed by the method of claim 13.

21. A method of forming clad piping and tubing comprising the steps of:
providing a support billet having an inner surface;
fitting a solid, corrosion resistant alloy billet inside the support billet;
Hot Iso-static Pressing the corrosion resistant alloy billet against the inner surface of the support billet to metallurgically bond the corrosion resistant alloy billet to the support billet to form a composite billet; and
hot rolling the composite billet to compress and reduce the composite billet to form at least one of the clad piping and tubing.

22. The method in accordance with claim 21 further including the step of trepanning the corrosion resistant alloy portion of the composite billet.

23. The method in accordance with claim 21, wherein the support billet is cylindrical.

24. A product formed by the method of claim 21.

25. A method of forming clad piping and tubing comprising the steps of:
providing a support billet having an inner surface;
applying a solid, corrosion resistant alloy billet inside the support billet; and
hot rolling the composite billet to compress and reduce the composite billet to form at least one of the clad piping and tubing.

26. The method in accordance with claim 25 wherein the corrosion resistant alloy billet is applied inside the support billet by a weld overlay process.

27. A product formed by the method of claim 25.
